(19) United States
(12) Patent Application Publication
(10) Pub. No.: US 2002/0112386 A1
(43) Pub. Date: Aug. 22, 2002

(54) Lampshade to display and illuminate translucent images

(76) Inventor: Allen S. Thomas, Houston, TX (US)

Correspondence Address: CONLEY ROSE & TAYON, P.C., P. O. BOX 3267, HOUSTON, TX, 77253-3267, US

(21) Appl. No.: 10/073,776

(22) Filed: Feb. 11, 2002

Related U.S. Application Data
(60) Provisional application No. 60/268,557, filed on Feb. 14, 2001.

(51) Int. Cl. G09F 13/00

(52) U.S. Cl. 40/554

(57) ABSTRACT

A lampshade that is capable of retaining and illuminating images printed upon a translucent film material is presented. The lampshade is preferably manufactured of a smooth opaque plastic material that is capable of transmitting light efficiently therethrough. Translucent film images are then placed about the periphery of the lampshade and held in place by a clear plastic overlay, a static cling device, or tape. One preferred embodiment of the present invention includes a standard conic sectioned lampshade whereby the geometry of the shade helps to hold the image in place. A second preferred embodiment of the present invention included a lampshade that is substantially cylindrical in shape and employs a bottom ledge in conjunction with the clear plastic overlay to retain the image securely in place.

### CROSS REFERENCE TO RELATED APPLICATIONS

This application claims benefit of priority of U.S. provisional application Serial No. 60/268,557 filed Feb. 14, 2001, and entitled “Lampshade to Display and Illuminate Translucent Images,” which is incorporated herein by reference.

### STATEMENT REGARDING FEDERALLY SPONSORED RESEARCH OR DEVELOPMENT

Not Applicable.

### FIELD OF THE INVENTION

The present invention relates to a device for mounting translucent materials for display purposes. More particularly, the present invention relates to a shade for a lamp that is configured to retain a translucent image and transmit light therethrough as the lamp is activated such that the image is illuminated and visible from a distance, regardless of ambient light circumstances.

### BACKGROUND OF THE INVENTION

Although there are many ways for illuminating and displaying graphical images and materials (i.e. photographs, holograms, art prints, etc), the most popular method of display involves placing them in a frame, setting them on a table, or hanging them from a wall. Typically, a spotlight, or other direct or indirect illumination source, shines on the image, thus enabling an audience to observe the image. Alternatively, such images may be represented upon photographic “slides” and projected upon a surface, preferably a white screen, to be seen, however such presentations require significant equipment costs and preparation to perform properly. Although both methods for illuminating and displaying such images are effective, a new and unique approach would be well received by the general public.

### BRIEF SUMMARY OF THE INVENTION

The deficiencies of the prior art can be addressed by a lampshade that is capable of retaining images printed upon a translucent film material. The lampshade is preferably manufactured of a neutrally colored opaque material that is capable of transmitting light efficiently therethrough. The translucent film images are then placed about the periphery of the lampshade and partially held in place by a clear plastic overlay. One preferred embodiment of the present invention includes a standard conic sectioned lampshade whereby the geometry of the shade helps to hold the image in place. A second preferred embodiment of the present invention includes a lampshade that is substantially cylindrical in shape and employs a bottom ledge in conjunction with the clear plastic overlay to retain the image securely in place.

### BRIEF DESCRIPTION OF THE DRAWINGS

For a detailed description of a preferred embodiment of the invention, reference will now be made to the accompanying drawings wherein:

FIG. 1 is a perspective view drawing of a lampshade in accordance with a preferred embodiment of the present invention;

FIG. 2 is an enlarged profile view of the lampshade of FIG. 1;

FIG. 3 is a plan view of an unwrapped covering in accordance with a preferred embodiment that is to be placed about the periphery of the lampshade of FIG. 1;

FIG. 4 is an exploded perspective view drawing of the lampshade of FIG. 1 and the covering of FIG. 3 prior to assembly with a translucent image in accordance with a preferred embodiment of the present invention;

FIG. 5 is a top view assembly drawing showing the lampshade, covering, and translucent image of FIG. 4 in an assembled position;

FIG. 6 is a perspective representation of a lampshade in accordance with another preferred embodiment of the present invention;

FIG. 7 is a close up perspective representation of a bottom ring portion of the lampshade of FIG. 6;

FIG. 8 is a perspective representation of the lampshade of FIG. 6 with a translucent photograph mounted thereupon;

FIG. 9 is a perspective representation of the lampshade of FIG. 6 with a three-dimensional translucent image mounted thereupon;

FIG. 10 is a perspective representation of the lampshade of FIG. 6 with another three dimensional translucent image mounted thereupon; and

FIG. 11 is a close up perspective representation of the bottom ring portion of the lampshade of FIG. 6 with clear plastic tubing mounted thereupon.

### DESCRIPTION OF PREFERRED EMBODIMENTS

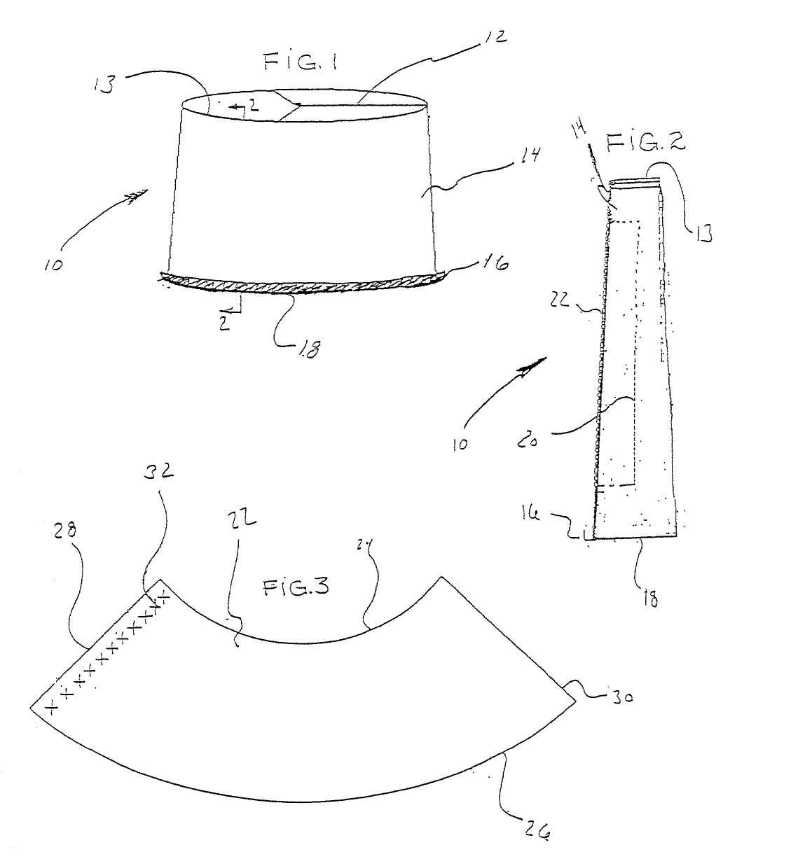

Referring initially to FIG. 1, a lampshade 10 to illuminate translucent graphical images is shown. Lampshade 10 includes a structural frame 12 at its top 13, an outer profile 14, and a retaining ledge 16 at its bottom 18. Lampshade 10 is preferably constructed as a truncated cone, with the top edge 13 and bottom edge 18 of outer profile 14 having substantially dissimilar circular geometries. Lampshade 10 outer profile 14 is preferably made of a hard, white frosted translucent plastic or hard paper to illuminate the shade uniformly for displaying translucent materials and offer a solid white background behind the translucent material for better viewing. Furthermore, outer surface 14 provides a smooth hard surface to mount and hold the image material. The design of shade 10 allows it to fit on most standard table and floor lamps with construction and cost of the lampshade being similar to conventional lampshades. An ideal candidate for the material of profile 14 of lampshade 10 would therefore be a material capable of emitting as much white light therethrough as possible without allowing an observer to view the contents of any light source or framework 12 within lampshade 10. Candidate materials for outer profile 14 would be coated opaque white papers, fabrics, and plastic (preferably styrene), or hard, white extruded plastic.

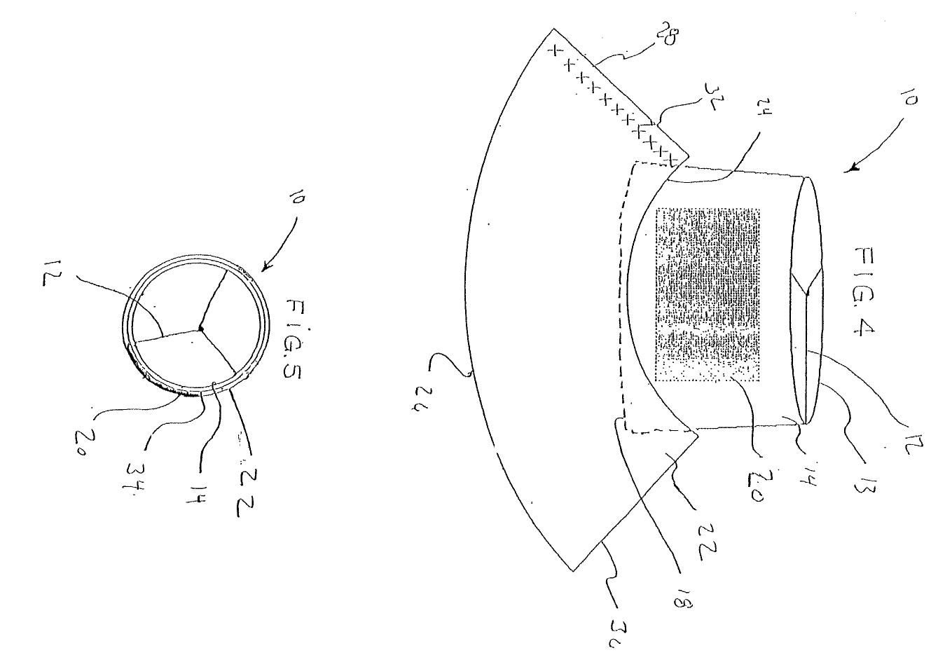

Referring now to FIG. 2 a profile view of lampshade 10 is shown. In this view, retaining ledge 16 can be seen to closely resemble a hook extended about the circumference of the bottom edge 18 of shade 10. Although ledge 16 is shown as a formed hook-shaped rotation, it should be understood that ledge can take the form of any geometry that is capable of retaining a substantially flat image or piece of film upon outer profile 14 of shade 10. Examples of retaining ledge 16 can include but are not limited to, a structural wire ring, a bent or formed piece of rigid material, or even a piece of plastic tubing sliced along its length and placed over the bottom circumference of shade 10.

Still referring to FIG. 2, a translucent image 20 can be placed about the periphery of outer profile 14 and is preferably secured in place by a clear plastic shield 22. Image 20 can be of any variety of translucent media but it has been discovered that “Duratrans” photographic film yields the best results. When image 20 is placed against outer profile 14 of lampshade 10, the bottom edge of image 20 abuts ledge 16 to stay in place (not shown). Ledge 16 preferably protrudes away from bottom 18 of shade by 1/16 to ⅛ of an inch. While image 20 is upon profile 14 clear plastic shield 22 is wrapped completely around profile 14 and secured with clear, adhesive tape (not shown). As the lamp is illuminated, light shines from a bulb (not shown) inside shade 10, and through shade 10, image 20, and shield 22 simultaneously, thereby illuminating image 20.

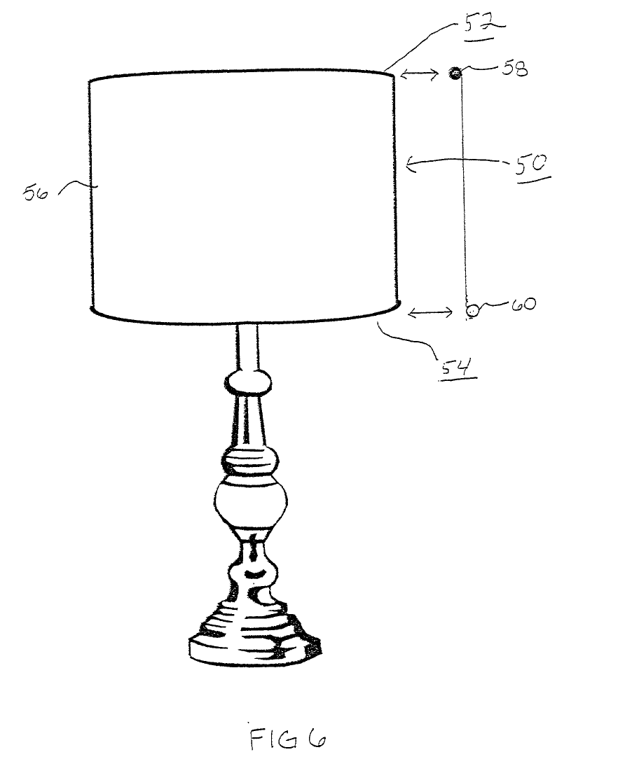

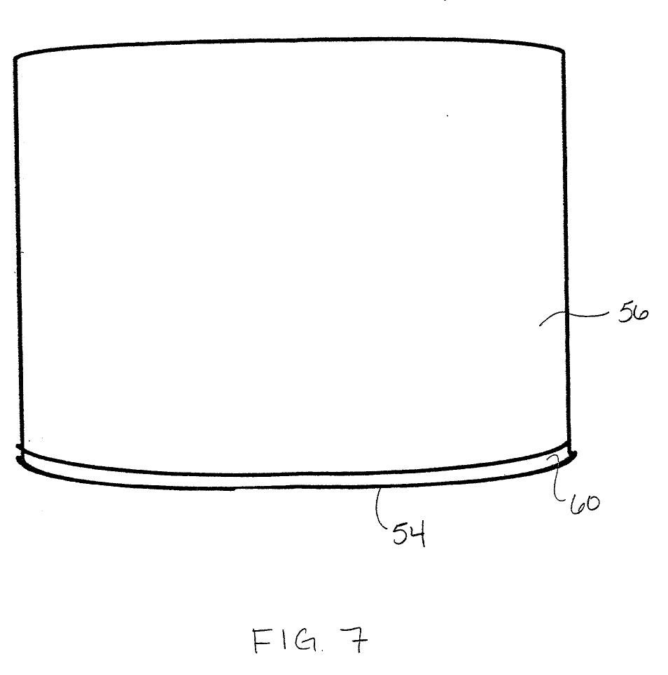

Referring now to FIG. 3, clear plastic shield 22 is shown unwrapped. Shield 22 includes a top portion 24, a bottom portion 26, and two ends 28, 30. Referring now to FIGS. 3 and 4, shield 22 is attached to shade 10, adhesive tape (not shown) is attached at location 32 and shield 22 is wrapped around image 20 and outer profile 14 of shade 10 until end 30 overlaps end 28 and sticks to adhesive tape at 32. When in place, top edge 24 of shield 22 substantially corresponds with top edge 13 of shade 10, while bottom edge 26 of shield substantially corresponds with bottom edge 18 of shade 10. Referring now to FIG. 5 a top view of a completed lampshade 10 with image 20 “sandwiched” between outer profile 14 and clear shield 22 is shown.

Referring to FIGS. 4 and 5 together, lampshade 10 can further include another clear plastic pane of static cling material 34. Static cling material 34, commonly called “Spar-Cal,” is capable of allowing plastic materials, including translucent image 20 and clear shield 22, to cling thereupon about the outer profile 14 of shade 10. FIG. 5 details a top view arrangement of shade 10, static cling material 34, image 20, and the outer clear shield 22 in an assembled state.

While cone shaped shades 10 described above and shown in FIGS. 1-5 are most common because their geometries allow them to be stacked and packaged efficiently, the shape of their outer profiles makes producing outer wraps to be mounted thereupon difficult. The outer shield 22 of lampshade 10 must take the form of an irregular shape with both curved and straight cuts, with the curved cuts being the most difficult and time consuming. A successful manufacturer of shade 10 must be able to properly measure and cut wrap 22 with the proper curvature for the upper 24 and bottom 26 portions and cut the proper angle and locations for the ends 28 and 30.

Referring now to FIG. 6, an alternative, cylindrical embodiment 50 to the lampshade of FIGS. 1-5 is shown. Cylindrical lampshade 50 functions in the same manner as lampshade 10 of FIGS. 1-5 but has top 52 and bottom 54 edges of outer profile 56 that are substantially equal circular geometry. Edges 52, 54 of outer profile 56 are preferably constructed of wire rings 58, 60. Whereas wire ring 58 of top edge 52 is constructed along the inside of outer profile 56, wire ring 60 is constructed along the outside of outer profile 56. By placing ring 60 upon the outer side of outer profile, ring 60 can therefore be used to abut any objects that are wrapped around profile 56.

FIG. 7 details a close-up view of ring 60 of bottom edge 54 of outer profile 56. The outside placement of ring 60 is preferred for lampshade 50 because the cylindrical geometry of shade 50 will not allow dressings to remain in place without secondary support. Rather than physically adhere or tape dressings upon shade 50, the outside placement of ring 60 abuts such dressings and keeps them from sliding off of outer profile 56 under the influence of gravity.

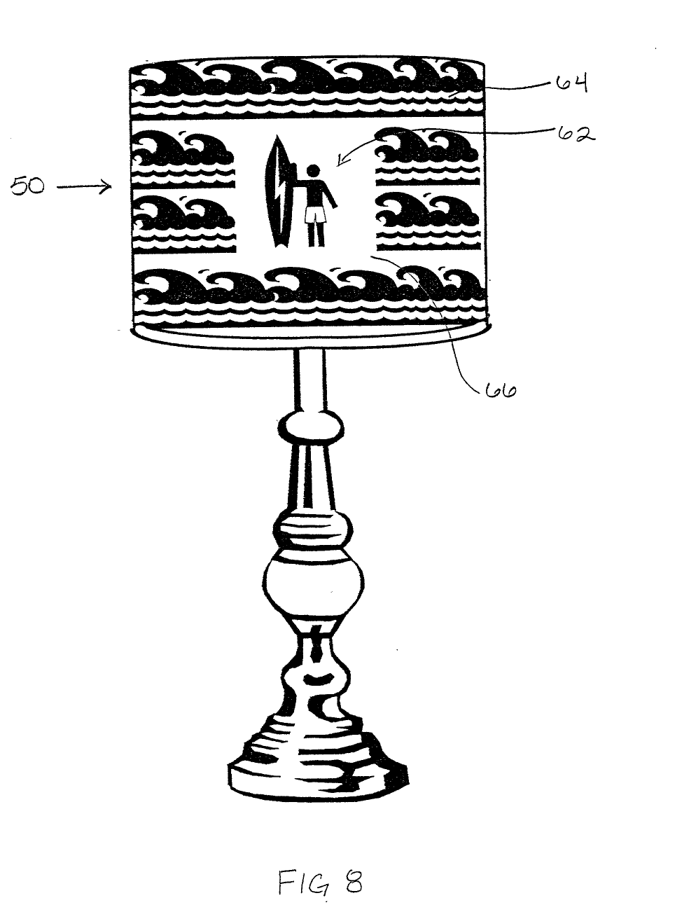

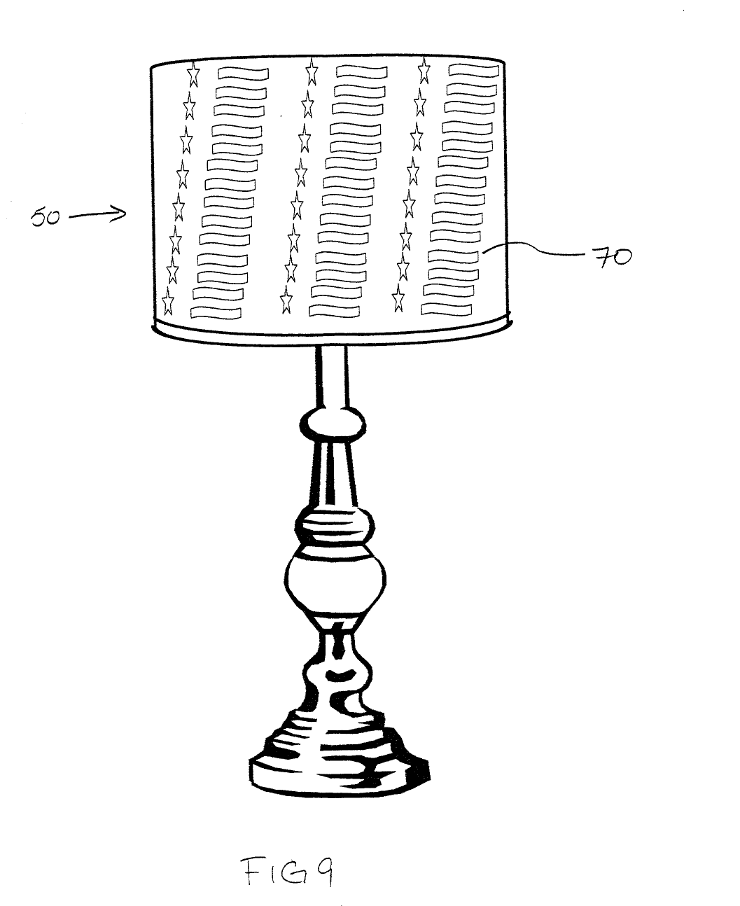

Referring now to FIG. 8, a photographic image 62 is shown mounted upon the outside of shade 50 and held in place by an outer shield 64. Although outer shield 64 may be clear or otherwise opaque, outer shield 64 of FIG. 8 has been produced with a decorative secondary image to produce the effect of a “framed” window 66 through which to view photographic image 62.

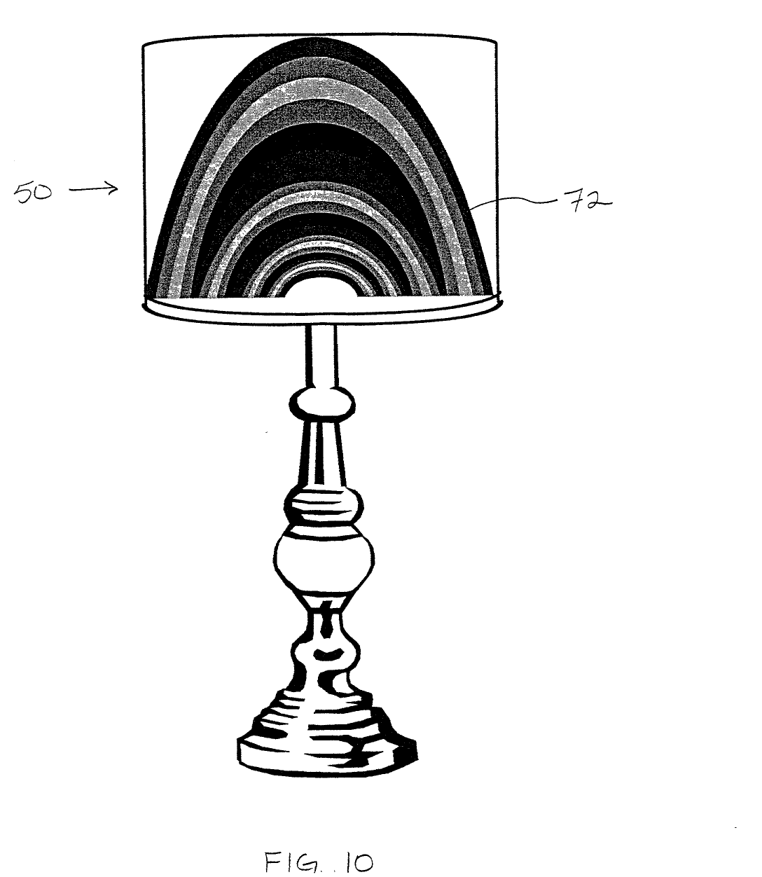

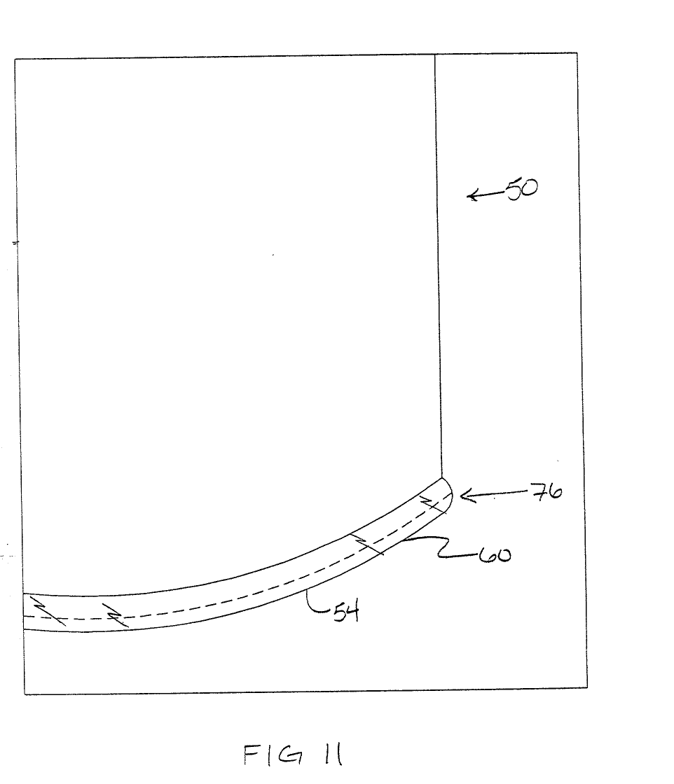

Referring now to FIGS. 9 and 10, two examples of design wraps 70, 72 are shown upon shade 50. Design 70 is a stars and stripes image while design 72 is a multi-colored rainbow design, however designs 70,72 may be of any color, pattern, or style that is appealing to the user, including three dimensional (3-D) images, holograms, and patterns. Designs for wraps 70, 72 may include a clear outer shield similar to shield 22 of FIGS. 2-5 or they may be printed directly upon the shield to create a single-piece construction.

With lampshade 50 in a cylindrical shape, the wrap-around decorations (64, 70, and 72 of FIGS. 8, 9 and 10 respectively) can slide off the shade. As mentioned in reference to FIG. 6 above, this issue can be corrected by constructing bottom ring 60 of shade 50 such that it supports the shade is on the outside of outer profile 56, and not on the inside of outer profile 56 as in common in most conventional shades. Ring 60 on the bottom of outer profile 56 acts as a shelf for the decorative wraps (64, 70, or 72) to rest on, thus preventing them from sliding off.

Referring now to FIG. 11, the bottom edge 54 of lampshade 50 is shown with a piece of plastic tubing 76 has been added about wire ring 60. Tubing 76 is preferably a standard 5/16″ OD, 3/16″ ID clear plastic tubing that is cut along its length to allow it to “snap” over the profile of bottom wire ring 60. Tubing 76 serves to increase the effective diameter of ring 60 as well as to provide additional friction resistance to assist in retaining a dressing (64, 70, and 72 of FIGS. 8,9, and 10, respectively) upon shade 50.

Because shade 50 of FIGS. 6-11 is cylindrical, wraps or shields (64, 70, or 72 from FIGS. 8, 9, and 10 respectively) will be rectangular in shape. Such rectangular wraps and shields are much easier to manufacture than the complex shape of shield 22 of FIGS. 2-5. Although cylindrical shades 50 can not be stacked as conical shades 10, the additional costs in shipping and storage of cylindrical shades 50 may be justified by the ease of manufacture of materials that are wrapped about their outer profiles 56.

Shades 10 and 50 of FIGS. 1-11 allow translucent materials and overlays to be changed quickly, easily and inexpensively, thus allowing unlimited ways to customize the lampshade to ones personal taste and liking. Lampshades 10 and 50 can accommodate different quantities, sizes, and shape of pictures and are only limited by the size of the shade exterior. Translucent images are capable of being mounted anywhere on the outer perimeter of the lampshade which is beneficial for the displaying of panoramic pictures upon the shade. A lampshade in accordance with the present invention can be decorated in unlimited ways, and only limited by the owner's imagination. There are abundant sources of translucent materials from which to chose from including, but not limited to, panes that are printed with pictures, designs, patterns, holograms, team logos, flags, art, or promotional advertisements.

While a preferred embodiment of the invention has been shown and described, modifications thereof can be made by one skilled in the art without departing from the spirit of the invention.

What is claimed is:

1. A decorative shade for a lamp, the shade comprising:
an outer profile to surround the lamp, said outer profile having a bottom and a top edge;
said outer profile comprising a substantially uniform material, said material selected to translucently re-emit light from the lamp through said outer profile; and
a replaceable translucent film image mounted upon said outer profile, said film image configured to be illuminated when the lamp emits light through said outer profile.

2. The decorative shade for a lamp of claim 1 wherein said bottom edge is configured to maintain said translucent film image upon the shade.

3. The decorative shade of claim 1 further comprising a clear protective shield to enwrap said graphical image and said outer profile.

4. The decorative shade of claim 3 wherein secondary images are printed upon said protective shield.

5. The decorative shade of claim 4 wherein said secondary images create a framed border around said film image.

6. The decorative shade of claim 2 wherein said bottom edge includes a wire ring.

7. The decorative shade of claim 6 wherein the inner diameter of said wire ring is mounted upon the outside of said outer profile.

8. The decorative shade of claim 6 wherein said wire ring includes a length of plastic tubing mounted thereupon.

9. The decorative shade of claim 2 wherein said bottom edge includes a ledge.

10. The decorative shade of claim 1 wherein the shade further comprises a structural frame, said structural frame configured to support said outer profile about an axis defined by the lamp.

11. The decorative shade of claim 1 wherein said outer profile is shaped as a tapered cone.

12. The decorative shade of claim 1 wherein said outer profile is shaped as a cylinder.

13. A method for displaying a graphical image upon a lampshade of a lamp, wherein the lampshade is configured to transmit a substantial amount of light through an outer profile, the method comprising:
placing a translucent film slide upon the outer profile, said translucent film slide comprising an image to be displayed and illuminated by the lamp.

14. The method of claim 13 wherein the outer profile includes a feature at its bottom to maintain the film slide in place.

15. The method of claim 14 wherein the feature at the bottom of the outer profile is a wire ring.

16. The method of claim 15 wherein the wire ring is enlarged by a length of plastic tubing.

17. The method of claim 14 wherein the feature at the bottom of the outer profile is a rigid ledge.

18. The method of claim 13 further comprising affixing a transparent shield upon the lampshade to cover the outer profile and the film slide.

19. The method of claim 18 wherein the transparent shield is printed with translucent designs.

20. The method of claim 19 wherein said translucent designs create a framed border around the image of the film slide.
